(19) United States
(12) Patent Application Publication
(10) Pub. No.: US 2023/0303109 A1
(43) Pub. Date: Sep. 28, 2023

(54) RECOMMENDATION DEVICE AND RECOMMENDATION METHOD

(71) Applicant: HONDA MOTOR CO., LTD., Tokyo (JP)

(72) Inventors: Keigo Nakada, Tokyo (JP); Daisuke Ide, Tokyo (JP); Yujiro Kita, Tokyo (JP); Adil Gupta, Tokyo (JP); Shinya Yasuhara, Tokyo (JP); Yusuke Inoue, Tokyo (JP); Ko Uchida, Tokyo (JP)

(21) Appl. No.: 18/165,967

(22) Filed: Feb. 8, 2023

(30) Foreign Application Priority Data
Mar. 28, 2022 (JP) 2022-051724

(51) Int. Cl. B60W 50/14

(52) U.S. Cl. CPC B60W 50/14; B60W 2556/10; B60W 2556/45

(57) ABSTRACT

A recommendation device recommendation device acquires a moving route of the vehicle driven by a target user; specifies one or a plurality of driver assistance functions recommended to be used on the moving route and use recommended areas where the driver assistance functions are recommended to be used; evaluates a use record of the target user regarding the driver assistance functions specified; and outputs recommendation information for recommending: the driver assistance functions remaining after excluding the driver assistance functions for which an evaluation result of the use record of the target user corresponds to a prescribed condition from the driver assistance functions specified; and the respective use recommended areas of the driver assistance functions.

### INCORPORATION BY REFERENCE

The present application claims priority under 35 U.S.C. § 119 to Japanese Patent Application No. 2022-051724 filed on Mar. 28, 2022. The content of the application is incorporated herein by reference in its entirety.

### BACKGROUND OF THE INVENTION

### Field of the Invention

The present invention relates to a recommendation device and a recommendation method.

### Description of the Related Art

Japanese Patent Laid-Open No. 2020-165688 discloses a technology that superimposes and displays, on a map screen, display information regarding recommendation levels of autonomous driving based on the histories related to execution of autonomous driving in a plurality of vehicles. In Japanese Patent Laid-Open No. 2020-165688, it is disclosed that the technology makes it possible to display the recommendation level of autonomous driving in an easy-to-understand manner and to improve the convenience for the users of autonomous cars.

However, the users who are accustomed to using autonomous driving on a regular basis may feel annoyed about the display related to recommendation of autonomous driving.

Note that such an issue is not limited only to autonomous driving but also to cases of recommending other driver assistance functions.

It is an object of the present invention to provide a recommendation device and a recommendation method capable of recommending a driver assistance function that is available in a vehicle in accordance with its user.

### SUMMARY OF THE INVENTION

One aspect of the present invention is a recommendation device recommending a driver assistance function available for a user who is driving a vehicle, and the recommendation device includes: a moving route acquisition unit configured to acquire a moving route of the vehicle driven by a target user that is the user as a recommendation target; a use recommended function/area specification unit configured to specify one or a plurality of the driver assistance functions recommended to be used on the moving route and use recommended areas where the driver assistance functions are recommended to be used; a per-user use record evaluation unit configured to evaluate a use record of the target user regarding the driver assistance functions specified by the use recommended function/area specification unit; and a recommendation unit configured to output recommendation information that recommends: the driver assistance functions remaining after excluding the driver assistance functions for which an evaluation result of the use record of the target user corresponds to a prescribed condition from the driver assistance functions specified by the use recommended function/area specification unit; and the respective use recommended areas of the driver assistance functions.

The recommendation device according to one aspect of the present invention includes: an information collection unit configured to collect information related to use of the driver assistance functions in a plurality of the vehicles; and an aggregation unit configured to aggregate the information related to the use collected by the information collection unit, in which the recommendation unit outputs the recommendation information that recommends the driver assistance functions and an aggregation result of the information related to the use of the driver assistance functions in an associated manner.

In the recommendation device according to one aspect of the present invention, the aggregation unit aggregates use frequency of the driver assistance functions in the plurality of vehicles, and the recommendation unit outputs the recommendation information that recommends the driver assistance functions and the use frequency regarding the driver assistance functions in an associated manner.

In the recommendation device according to one aspect of the present invention, the information related to the use contains a user evaluation for the driver assistance functions, and the recommendation unit outputs the recommendation information that recommends the driver assistance functions and an aggregated value of the user evaluation in an associated manner.

In the recommendation device according to one aspect of the present invention, the recommendation unit outputs the recommendation information that recommends the driver assistance functions and a reason for recommending the driver assistance functions in an associated manner.

In the recommendation device according to one aspect of the present invention, the moving route is a travel route in one cycle of past or future driving cycles of the vehicle.

One aspect of the present invention is a recommendation method used in a recommendation device that recommends a driver assistance function available for a user who is driving a vehicle, and the recommendation method includes: acquiring a moving route of the vehicle driven by a target user that is the user as a recommendation target; specifying one or a plurality of the driver assistance functions recommended to be used on the moving route and use recommended areas where the driver assistance functions are recommended to be used; evaluating a use record of the target user regarding the driver assistance functions specified by the use recommended function/area specification unit; and outputting recommendation information that recommends: the driver assistance functions remaining after excluding the driver assistance functions for which an evaluation result of the use record of the target user corresponds to a prescribed condition from the driver assistance functions specified by the use recommended function/area specification unit; and the respective use recommended areas of the driver assistance functions.

According to one aspect of the present invention, it is possible to recommend the driver assistance functions that are available in the vehicle in accordance with the user.

### BRIEF DESCRIPTION OF THE DRAWINGS

FIG. 1 is a diagram showing a configuration of a recommendation system according to an embodiment of the present invention;

FIG. 2 is a diagram showing a functional configuration of a vehicle system;

FIG. 3 is a diagram showing a functional configuration of a recommendation server;

FIG. 4 is a diagram showing a functional configuration of a client device;

FIG. 5 is a flowchart showing recommendation processing of the recommendation server; and

FIG. 6 is a diagram showing an example of display based on recommendation information.

### DETAILED DESCRIPTION OF THE PREFERRED EMBODIMENT

Hereinafter, an embodiment of the present invention will be described with reference to the accompanying drawings.

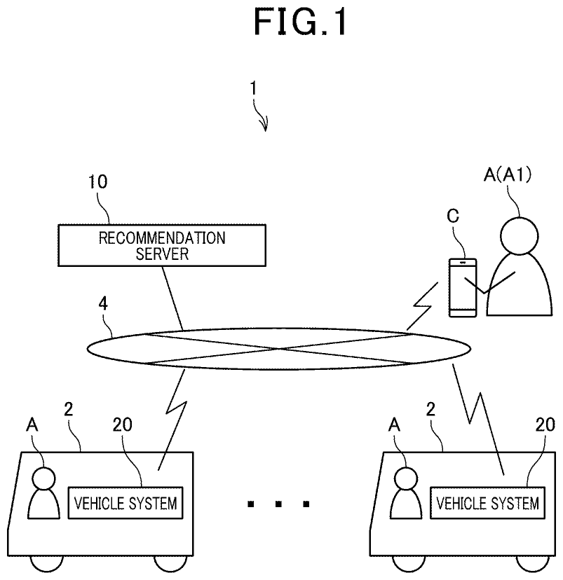

FIG. 1 is a diagram showing a configuration of a recommendation system 1 according to the embodiment.

The recommendation system 1 is a system that provides a recommendation service to a client device C through a telecommunication line 4 such as the Internet. The recommendation service according to the embodiment is a service for recommending driver assistance functions that are available in a vehicle 2 to a user A who is driving the vehicle 2.

The driver assistance functions are various kinds of functions for assisting the user A to drive the vehicle 2, and examples thereof may be an autonomous driving function, an automated following function, an anti-glare function, an adaptive cruise control function, an auto-braking operation function, and the like.

Furthermore, the recommendation system 1 according to the embodiment recommends the driver assistance functions to the user A by excluding the driver assistance functions that the user A may possibly be accustomed to using, based on a moving route E of the vehicle 2 driven by the user A and a use record of the user A regarding the driver assistance functions theretofore.

This makes it possible to suppress recommending the driver assistance functions that the user A is accustomed to using and to securely recommend the driver assistance functions that the user A is not accustomed to using. Therefore, an appropriate recommendation can be offered by corresponding to the user A.

Furthermore, in the embodiment, the moving route E may be a travel route in one cycle of past or future driving cycles of the vehicle 2. Thereby, the driver assistance functions are recommended to the user A targeted at the past travel route or the future travel route, so that the user A can utilize the recommendation service for review and preparation of the driver assistance functions to which they are unaccustomed.

Note that the driving cycle is a period where the user A uses the vehicle 2 for moving to a destination point from a departure point and, for example, a period from an operation of a start switch for starting a power source of the vehicle 2 to a next reoperation is set as one cycle may be used.

Next, the configuration related to the recommendation system 1 according to the embodiment will be described in detail.

As shown in FIG. 1, the recommendation system 1 includes a recommendation server 10 for providing the recommendation service described above. The recommendation server 10 has: an information collection function for collecting use history information Da from a plurality of vehicles 2 via the telecommunication line 4; an aggregation function for aggregating the use history information Da; and a recommendation function for recommending the driver assistance functions to the user A. Note that the specific functional configuration of the recommendation server 10 will be described later.

The use history information Da is information related to the history of the driver assistance functions used in the vehicle 2 by the user A. The vehicle 2 includes a vehicle system 20 that has functions of recording and transmitting the use history information Da.

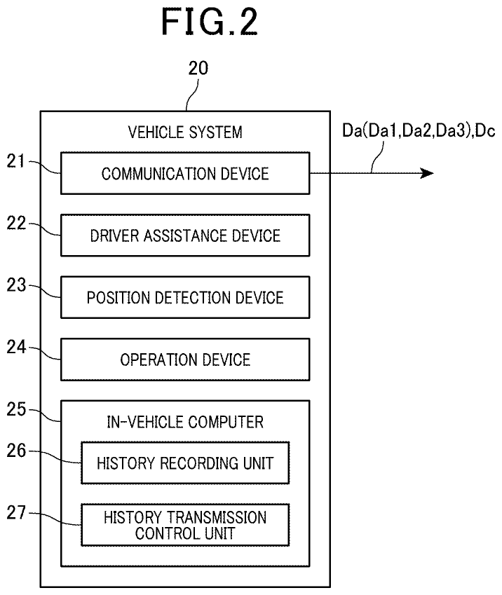

FIG. 2 is a diagram showing a functional configuration of the vehicle system 20.

The vehicle system 20 is a system that includes one or a plurality of in-vehicle devices loaded on the vehicle 2, and includes a communication device 21, a driver assistance device 22, a position detection device 23, an operation device 24, and an in-vehicle computer 25.

The communication device 21 is a device that has a transmitter and a receiver and communicates with the recommendation server 10 via the telecommunication line 4.

The driver assistance device 22 is a device that is configured with a computer comprising a processor and a memory and implements one or a plurality of driver assistance functions described above. Note that the vehicle system 20 may include a plurality of driver assistance devices 22.

The position detection device 23 is a device that detects the current position of the vehicle 2. The position detection device 23 according to the embodiment includes a GNSS (Global Navigation Satellite System) receiver that receives positioning signals transmitted from a plurality of positioning satellites, and specifies the position based on those positioning signals.

The operation device 24 is a device that receives operations of the user A, and it is a button, a touch panel, or the like. The operation device 24 is also used as evaluation input means where the user A who has used the driver assistance function inputs an evaluation regarding the usability and the like of the driver assistance function.

The in-vehicle computer 25 includes: a processor such as a CPU (Central Processing Unit) or an MPU (Micro-Processing Unit); a memory device (also referred to as a main memory device) such as a ROM (Read Only Memory) or a RAM (Random Access Memory); a storage device (also referred to as a subsidiary storage device) such as an HDD (Hard Disk Drive) or an SSD (Solid State Drive); and an interface circuit for connecting various peripheral devices (the communication device 21, the driver assistance device 22, the position detection device 23, the operation device 24, and the like).

Then, the functions related to recording and transmission of the use history information Da are implemented through executing a computer program stored in the memory device or the storage device by the processor.

Specifically, the in-vehicle computer 25 includes, as the functional configuration, a history recording unit 26 and a history transmission control unit 27.

The history recording unit 26 records, in the use history information Da, the information related to the use history of the user A regarding the driver assistance functions. The information related to the use history contains at least used function information Da1 indicating the used drive assistance function, used position information Da2 indicating the position of the vehicle 2 when the driver assistance function is used, and user evaluation information Da3 indicating the evaluation for the driver assistance function made by the user A. In addition to those, the information related to the use history may contain the date/time (date and time) at which the driver assistance function is used, information related to driving the vehicle 2 and surrounding environment (car speed, road congestion condition, presence of obstacles around, and the like) thereof. Such information related to driving and surrounding environment can be acquired from adequate in-vehicle devices (in-vehicle camera, vehicle control ECU (Electronic Control Unit), and the like) provided to the vehicle 2.

The history transmission control unit 27 executes control for transmitting the use history information Da to the recommendation server 10 from the communication device 21. Furthermore, when transmitting the use history information Da, the history transmission control unit 27 transmits the use history information Da by associating it with user identification information Dc that identifies the user A. Note that the transmission timings and transmission intervals of the use history information Da can be set as appropriate.

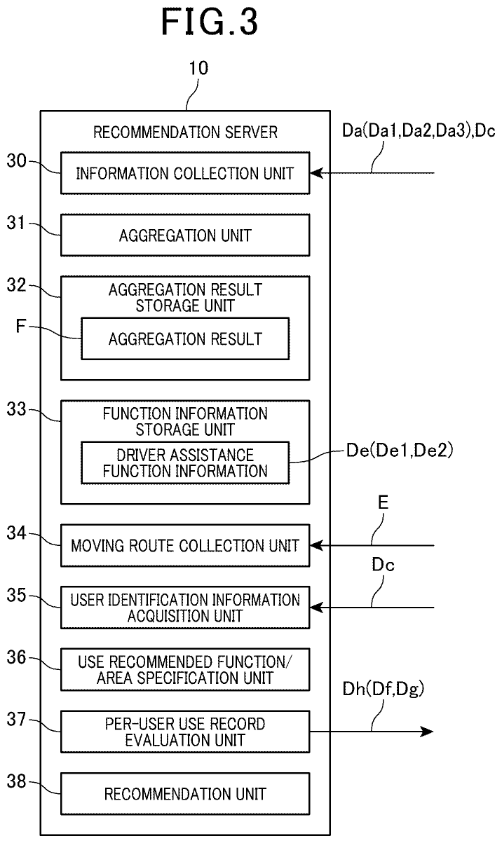

FIG. 3 is a diagram showing a functional configuration of the recommendation server 10.

The recommendation server 10 is a computer that includes a processor, a memory device, a storage device, a communication device (receiver and transmitter) that communicates via the telecommunication line 4, and an interface circuit for connecting various kinds of peripheral devices.

Then, various kinds of functions related to providing the recommendation service are implemented through executing a computer program stored in the memory device or the storage device by the processor.

Specifically, as the functional configuration, the processor of the recommendation server 10 functions as an information collection unit 30, an aggregation unit 31, an aggregation result storage unit 32, a function information storage unit 33, a moving route acquisition unit 34, a user identification information acquisition unit 35, a use recommended function/area specification unit 36, a per-user use record evaluation unit 37, and a recommendation unit 38.

The information collection unit 30 collects the use history information Da that is the information related to the use histories of the driver assistance functions in a plurality of vehicles 2. Specifically, the information collection unit 30 acquires the use history information Da transmitted at appropriate timings from each of the vehicles 2 via the communication device of the recommendation server 10.

The aggregation unit 31 aggregates the use history information Da collected from each of the vehicles 2 by the information collection unit 30. Specifically, the aggregation unit 31 aggregates, for each of the driver assistance functions, aggregated values of the used position information Da2 in each of the vehicles 2, aggregated values of the user evaluation information Da3 in each of the vehicles 2, and use frequencies in each of the vehicles 2.

Furthermore, the aggregation unit 31 specifies a high-frequency use area where the use frequency of each of the driver assistance functions is a prescribed value or more, based on the aggregated values of the used position information Da2.

Note that the aggregation unit 31 may specify the high-frequency use area for each time unit such as the used time zone or season, traveling states, and traveling environments.

Furthermore, the mode of aggregating the user evaluation information Da3 is determined as appropriate, and a 5-level evaluation is used in the embodiment.

The aggregation result storage unit 32 stores an aggregation result F of the use history information Da acquired by the aggregation unit 31. The aggregation result F of the embodiment contains the use frequency, the high-frequency use area, and the user evaluation aggregated value for each of the driver assistance functions.

The function information storage unit 33 stores in advance driver assistance function information De that is individual information of the driver assistance function. In the embodiment, the driver assistance function information De contains at least a usage De1 and a use method De2 of the corresponding driver assistance function.

The moving route acquisition unit 34 acquires: the moving route E of the user A as the target to which the driver assistance function is to be recommended, that is, the user A who is operating the client device C; and the user identification information Dc of the user A. The moving route E is transmitted from the client device C based on an operation of the user A, and received by the communication device of the recommendation server 10. Thereby, the moving route acquisition unit 34 acquires the moving route E.

Hereinafter, the user A as the target of recommendation (the user A who is operating the client terminal C) is referred to as a target user A1 to be distinguished from the other users A.

The user identification information acquisition unit 35 acquires the user identification information Dc of the target user A1 corresponding to the moving route E.

The use recommended function/area specification unit 36 specifies the driver assistance function that is recommended to be used (referred to as “use recommended function Df” hereinafter) and the area of the moving route E where the driver assistance function is recommended to be used (referred to as “use recommended area Dg” hereinafter) based on the moving route E of the target user A1 and the high-frequency use area of the aggregation result F.

Specifically, the use recommended function/area specification unit 36 specifies the high-frequency use areas where the moving route E passes through as the use recommended areas Dg, and specifies the driver assistance functions corresponding to each of the high-frequency use areas as the use recommended functions Df.

The per-user use record evaluation unit 37 evaluates the use record of the target user A1 regarding each of the use recommended functions Df specified by the use recommended function/area specification unit 36 based on the use history information Da associated with the target user A1.

Evaluation of the use record derives the information for making it possible to perform quantitative evaluation regarding how much the target user A1 is accustomed to using the use recommended function Df, and any evaluation methods may be used for that. In the embodiment, the number of times the target user A1 has used the use recommended function Df is derived by the evaluation of the use record and, when the number of use times is a prescribed value or more, it is considered that the target user A1 is accustomed to using the use recommended function Df (knows the usage and use method of the use recommended function Df).

The recommendation unit 38 generates recommendation information Dh that is the information for recommending, to the target user A1, the use recommended function Df and the use recommended area Dg in an associated manner, and executes control for transmitting the recommendation information Dh to the client device C from the communication device.

The recommendation information Dh is the information that contains at least the use recommended functions Df specified by the use recommended function/area specification unit 36, and the use recommended areas Dg of the respective use recommended functions Df. The recommendation information Dh of the embodiment further contains the use frequency, the user evaluation aggregated value, the reason for recommendation, and the use method De2 of the corresponding use recommended function Df.

The reason for recommendation is the reason why the use recommended function Df is recommended. The recommendation unit 38 of the embodiment specifies the reason for recommendation based on the relationship between the usage De1 of the use recommended function Df and the information (road information, obstacle information, and the like) related to the traveling environment of the use recommended area Dg. Note that the information related to the traveling environment of the use recommended area Dg is stored in advance in an adequate storage unit provided to the recommendation server 10. Furthermore, any well-known or publicly known techniques may be used for the method for specifying the reason for recommendation.

The recommendation unit 38 of the embodiment outputs the recommendation information Dh for recommending the use recommended functions Df from which the driver assistance functions for which the evaluation result of the use record of the target user A1 corresponds to a prescribed condition are excluded.

The prescribed condition is a condition with which the target user A1 can be considered to be accustomed to using the driver assistance function and, in the embodiment, it is defined such that the number of use times of the target user A1 equals to a prescribed number of times or more. That is, the recommendation unit 38 recommends the use recommended functions Df from which the driver assistance functions for which the number of use times is the prescribed number of times or more are excluded.

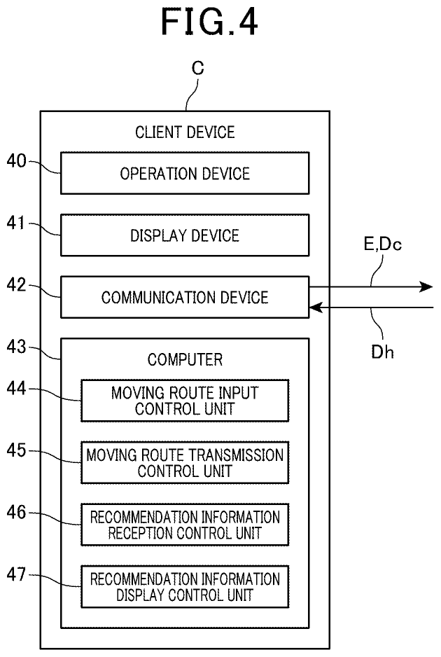

FIG. 4 is a diagram showing a functional configuration of the client device C.

The client device C is a device that receives recommendation of the use recommended function Df from the recommendation server 10. Examples of the client device C may be a mobile device such as a smartphone or a laptop PC, a desktop PC, an in-vehicle device loaded on the vehicle 2 (FIG. 1) where the target user A1 is riding, or the like.

As shown in FIG. 4, the client device C includes an operation device 40, a display device 41, a communication device 42, and a computer 43.

The operation device 40 is a device that receives operations of the user A, and it is a button, a touch panel, or the like. The display device 41 is a device that displays various kinds of information. The communication device 42 is a device that communicates with the recommendation server 10 via the telecommunication line 4.

The computer 43 includes a processor, a memory device, a storage device, and an interface circuit for connecting various kinds of peripheral devices (the operation device 40, the display device 41, the communication device 42, and the like).

Then, various kinds of functions related to a client computer that receives the recommendation service are implemented through executing a computer program stored in the memory device or the storage device by the processor.

Specifically, as the functional configuration, the computer 43 includes a moving route input control unit 44, a moving route transmission control unit 45, a recommendation information reception control unit 46, and a recommendation information display control unit 47.

The moving route input control unit 44 executes control for receiving input of the moving route E from the target user A1 via the operation device 40.

The moving route transmission control unit 45 executes control for transmitting the moving route E to the recommendation server 10 from the communication device 42. Furthermore, when transmitting the moving route E, the moving route transmission control unit 45 associates it with the user identification information Dc of the target user A1.

The recommendation information reception control unit 46 executes control for receiving the recommendation information Dh from the recommendation server 10 by the communication device 42.

The recommendation information display control unit 47 executes control for displaying the information related to recommending the use recommended function Df on the display device 41 based on the recommendation information Dh. A specific mode of the display will be described later.

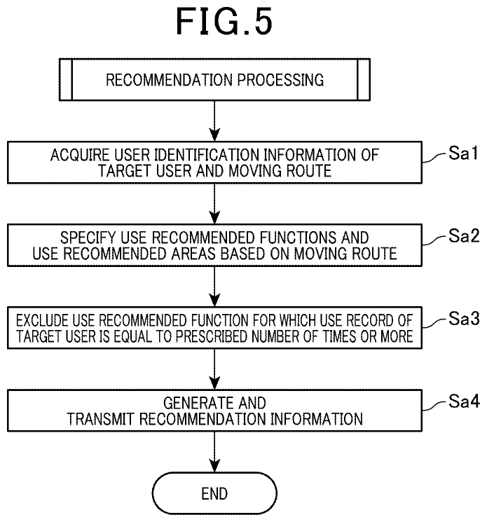

FIG. 5 is a flowchart showing recommendation processing of the recommendation server 10.

The recommendation processing is processing of the recommendation server 10 for recommending the user recommended functions Df and the use recommended areas Dg to the target user A1.

Specifically, in the recommendation server 10, the moving route acquisition unit 34 acquires the moving route E, and the user identification information acquisition unit 35 acquires the user identification information Dc of the target user A1 (Step Sa1).

Then, the use recommended function/area specification unit 36 specifies the use recommended functions Df and the use recommended areas Dg based on the moving route E and the aggregation result F (high-frequency use area) (Step Sa2).

Then, the per-user use record evaluation unit 37 specifies the use recommended functions Df for which the use record evaluation of the target user A1 corresponds to a prescribed condition (in the embodiment, the number of use times equals to a prescribed number of times or more), and exclude those from each of the use recommended functions Df specified in Step Sa2, based on the use history information Da corresponding to the user identification information Dc of the target user A1 (Step Sa3).

Then, the recommendation unit 38 generates the recommendation information Dh for recommending each of the use recommended functions Df after the exclusion, and transmits the recommendation information Dh to the client device C (Step Sa4).

The recommendation information Dh contains the use recommended area Dg, the use frequency, the user evaluation aggregated value, the reason for recommendation, and the use method De2 for each of the use recommended functions Df, and the client device C shows display for the recommendation on the display device 41 based on the recommendation information Dh.

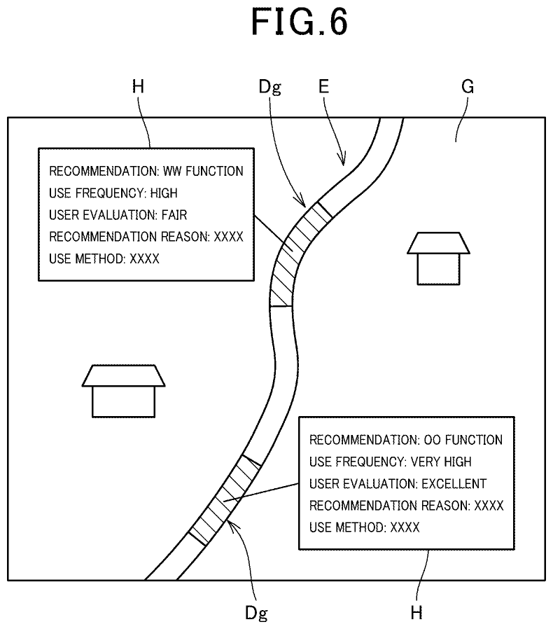

FIG. 6 is a diagram showing an example of the display based on the recommendation information Dh.

As shown therein, the use recommended functions Df are recommended by the client device C by superimposing and displaying each piece of information contained in the recommendation information Dh on a map G that includes the moving route E. Note that the data source of the map G may be provided to the client device C, may be an adequate server computer, or the recommendation information Dh may contain the data of the map G.

The use recommended areas Dg where the moving route E passes through are displayed in a mode (color, hatching, or the like) distinguishable from other routes, and information display sections H are displayed by being associated with respective use recommended areas Dg. The information display section H is for displaying each piece of information contained in the recommendation information Dh, and the name (“recommendation” in the drawing), the use frequency, the user evaluation aggregated value (“user evaluation” in the drawing), and the use method of the use recommended function Df are displayed in the embodiment.

In the display, the driver assistance functions that the target user A1 is accustomed to using are excluded from the use recommended functions Df, so that the target user A1 does not feel annoyed. Furthermore, the target user A1 can see the use recommended areas Dg of the use recommended functions Df that the target user A1 is not accustomed to using.

Furthermore, since the information based on the aggregation result F of the use history information Da in a plurality of vehicles 2 is displayed in the information display sections H, the target user A1 who is not accustomed to using the use recommended functions Df can grasp the use states of the use recommended functions Df in the use recommended areas Dg regarding the other users A, and can use the use recommended functions Df without any concern.

Especially, the use frequency of the use recommended function Df in a plurality of vehicles 2 is displayed in the information display section H, so that the target user A1 who is not accustomed to using the use recommended function Df can grasp in what level of frequency the use recommended function Df is used in the use recommended area Dg by the other users A.

Furthermore, since the user evaluation aggregated value of the use recommended function Df of a plurality of vehicles 2 is displayed in the information display section H, it is possible to determine whether to use the use recommended function Df based on the evaluations of the other users A.

Moreover, the reason for recommending the use recommended function Df is displayed in the information display section H, so that the target user A1 who is not accustomed to using the use recommended function Df can use the use recommended function Df with confidence by grasping the reason for using the use recommended function Df in the use recommended area Dg.

Following effects can be achieved by the embodiment.

The recommendation server 10 according to the embodiment is a device that recommends the driver assistance functions available for the user A who is driving the vehicle 2. The recommendation server 10 includes: the moving route acquisition unit 34 that acquires the moving route E of the vehicle 2 driven by the target user A1 that is the user A as the recommendation target; the use recommended function/area specification unit 36 that specifies one or a plurality of driver assistance functions (use recommended functions Df) recommended to be used on the moving route E and the use recommended areas Dg where the use of the use recommended functions Df are recommended; and the per-user use record evaluation unit 37 that evaluates the use record of the target user A1 regarding the use recommended functions Df. Furthermore, the recommendation server 10 includes the recommendation unit 38 that outputs (transmits) the recommendation information Dh for recommending the use recommended functions Df from which the use recommended functions Df for which the evaluation result of the use record of the target user A1 corresponds to a prescribed condition are excluded, and the use recommended areas Dg of the respective use recommended functions Df.

With such a configuration, it is possible to suppress recommending the driver assistance functions that the target user A1 is accustomed to using and also to securely recommend the driver assistance functions that the target user A1 is not accustomed to using as well as the use recommended areas Dg thereof. Therefore, an appropriate recommendation can be offered by corresponding to the target user A1.

The recommendation server 10 according to the embodiment includes: the information collection unit 30 that collects the use history information Da containing the information related to the use of the driver assistance functions in a plurality of vehicles 2; and the aggregation unit 31 that aggregates the use history information Da collected by the information collection unit 30. Then, the recommendation unit 38 outputs the recommendation information Dh for recommending the use recommended function Df and the aggregation result F regarding the use recommended function Df in an associated manner.

With such a configuration, the target user A1 who is not accustomed to using the use recommended function Df can grasp the use states of the use recommended function Df in the use recommended area Dg regarding the other users A, and can use the use recommended function Df without any concern.

In the recommendation server 10 according to the embodiment, the aggregation unit 31 aggregates the user frequency of the driver assistance function in a plurality of vehicles 2, and the recommendation unit 38 outputs the recommendation information Dh for recommending the use recommended function Df and the use frequency of the use recommended function Df in an associated manner.

With such a configuration, the target user A1 who is not accustomed to using the use recommended function Df can grasp in what level of frequency the use recommended function Df is used in the use recommended area Dg by the other users A.

In the recommendation server 10 according to the embodiment, the use history information Da contains the user evaluation for the driver assistance function, and the recommendation unit 38 outputs the recommendation information Dh for recommending the use recommended function Df and the user evaluation aggregated value in an associated manner.

With such a configuration, the target user A1 who is not accustomed to using the use recommended function Df can determine whether to use the use recommended function Df based on the evaluations of the other users A regarding the use recommended function Df.

In the recommendation server 10 of the embodiment, the recommendation unit 38 outputs the recommendation information Dh for recommending the use recommended function Df and the reason for recommending the use recommended function Df in an associated manner.

With such a configuration, the target user A1 who is not accustomed to using the use recommended function Df can use the use recommended function Df with confidence by grasping the reason for using the use recommended function Df in the use recommended area Dg.

In the recommendation server 10 according to the embodiment, the moving route E is a travel route in one cycle of past or future driving cycles of the vehicle 2.

With such a configuration, the target user A1 can do review and preparation of the driver assistance functions to which they are unaccustomed for the past or future travel routes.

Note that the embodiment described above is simply an example of one aspect of the present invention. That is, it is to be noted that any modifications and applications of the embodiment described above are possible without departing from the gist and scope of the present invention, and that each aspect related to the embodiment, modifications, and applications can be combined as appropriate.

In the embodiment described above, the recommendation server 10 does not need to have the server function for providing the recommendation service, but may be a recommendation device configured using a non-server computer.

Each of the drawings showing the functional configuration of the embodiment described above is a schematic view showing the structural elements classified in accordance with the main processing contents in order to facilitate understanding of the present invention, and the structural elements may be classified into a greater number of structural elements in accordance with the processing contents. Furthermore, classification may be made such that one structural element executes more kinds of processing.

### Configuration Supported by the Embodiment

The above-described embodiment supports the following items.

(Item 1) A recommendation device recommending a driver assistance function available for a user who is driving a vehicle, the recommendation device including: a moving route acquisition unit configured to acquire a moving route of the vehicle driven by a target user that is the user as a recommendation target; a use recommended function/area specification unit configured to specify one or a plurality of the driver assistance functions recommended to be used on the moving route and use recommended areas where the driver assistance functions are recommended to be used; a per-user use record evaluation unit configured to evaluate a use record of the target user regarding the driver assistance functions specified by the use recommended function/area specification unit; and a recommendation unit configured to output recommendation information that recommends: the driver assistance functions remaining after excluding the driver assistance functions for which an evaluation result of the use record of the target user corresponds to a prescribed condition from the driver assistance functions specified by the use recommended function/area specification unit; and the respective use recommended areas of the driver assistance functions.

According to item 1, it is possible to offer a recommendation in accordance with the target user.

(Item 2) The recommendation device according to item 1, including: an information collection unit configured to collect information related to use of the driver assistance functions in a plurality of the vehicles; and an aggregation unit configured to aggregate the information related to the use collected by the information collection unit, in which the recommendation unit outputs the recommendation information that recommends the driver assistance functions and an aggregation result of the information related to the use of the driver assistance functions in an associated manner.

According to item 2, the target user can grasp the use states of the driver assistance functions in the use recommended area regarding the other users.

(Item 3) The recommendation device according to item 2, in which the aggregation unit aggregates use frequency of the driver assistance functions in the plurality of vehicles, and the recommendation unit outputs the recommendation information that recommends the driver assistance functions and the use frequency regarding the driver assistance functions in an associated manner.

According to item 3, the target user can grasp in what level of frequency the use recommended function is used in the use recommended area by the other users.

(Item 4) The recommendation device according to item 2 or 3, in which the information related to the use contains a user evaluation for the driver assistance functions, and the recommendation unit outputs the recommendation information that recommends the driver assistance functions and an aggregated value of the user evaluation in an associated manner.

According to item 4, the target user can refer to the evaluation of the other users regarding the driver assistance functions.

(Item 5) The recommendation device according to any one of items 2 to 4, in which the recommendation unit outputs the recommendation information that recommends the driver assistance functions and a reason for recommending the driver assistance functions in an associated manner.

According to item 5, the target user can grasp the reason for using the driver assistance functions in the use recommended area.

(Item 6) The recommendation device according to any one of items 1 to 5, in which the moving route is a travel route in one cycle of past or future driving cycles of the vehicle.

According to item 6, the target user can do review and preparation of the driver assistance functions to which they are unaccustomed for the past or future travel routes.

(Item 7) A recommendation method used in a recommendation device that recommends a driver assistance function available for a user who is driving a vehicle, the recommendation method including: acquiring a moving route of the vehicle driven by a target user that is the user as a recommendation target; specifying one or a plurality of the driver assistance functions recommended to be used on the moving route and use recommended areas where the driver assistance functions are recommended to be used; evaluating a use record of the target user regarding the driver assistance functions specified by the use recommended function/area specification unit; and outputting recommendation information that recommends: the driver assistance functions remaining after excluding the driver assistance functions for which an evaluation result of the use record of the target user corresponds to a prescribed condition from the driver assistance functions specified by the use recommended function/area specification unit; and the respective use recommended areas of the driver assistance functions.

According to item 7, it is possible to offer a recommendation in accordance with the target user.

### REFERENCE SIGNS LIST

1 Recommendation system
2 Vehicle
10 Recommendation server (recommendation device)
22 Driver assistance device
30 Information collection unit
31 Aggregation unit
32 Aggregation result storage unit
33 Function information storage unit
34 Moving route acquisition unit
35 User identification information acquisition unit
36 Use recommended function/area specification unit
37 Per-user use record evaluation unit
38 Recommendation unit
A User
A1 Target user A
Da Use history information
Da1 Used function information
Da2 Used position information
Da3 User evaluation information
Dc User identification information
De Driver assistance function information
Df Use recommended function
Dg Use recommended area
Dh Recommendation information
E Moving route
F Aggregation result
G Map
H Information display section

What is claimed is:

1. A recommendation device recommending a driver assistance function available for a user who is driving a vehicle, the recommendation device comprising:
a moving route acquisition unit configured to acquire a moving route of the vehicle driven by a target user that is the user as a recommendation target;
a use recommended function/area specification unit configured to specify one or a plurality of the driver assistance functions recommended to be used on the moving route and use recommended areas where the driver assistance functions are recommended to be used;
a per-user use record evaluation unit configured to evaluate a use record of the target user regarding the driver assistance functions specified by the use recommended function/area specification unit; and
a recommendation unit configured to output recommendation information that recommends: the driver assistance functions remaining after excluding the driver assistance functions for which an evaluation result of the use record of the target user corresponds to a prescribed condition from the driver assistance functions specified by the use recommended function/area specification unit; and the respective use recommended areas of the driver assistance functions.

2. The recommendation device according to claim 1, comprising:
an information collection unit configured to collect information related to use of the driver assistance functions in a plurality of the vehicles; and
an aggregation unit configured to aggregate the information related to the use collected by the information collection unit, wherein
the recommendation unit outputs the recommendation information that recommends the driver assistance functions and an aggregation result of the information related to the use of the driver assistance functions in an associated manner.

3. The recommendation device according to claim 2, wherein
the aggregation unit aggregates use frequency of the driver assistance functions in the plurality of vehicles, and
the recommendation unit outputs the recommendation information that recommends the driver assistance functions and the use frequency regarding the driver assistance functions in an associated manner.

4. The recommendation device according to claim 2, wherein
the information related to the use contains a user evaluation for the driver assistance functions, and
the recommendation unit outputs the recommendation information that recommends the driver assistance functions and an aggregated value of the user evaluation in an associated manner.

5. The recommendation device according to claim 2, wherein the recommendation unit outputs the recommendation information that recommends the driver assistance functions and a reason for recommending the driver assistance functions in an associated manner.

6. The recommendation device according to claim 1, wherein the moving route is a travel route in one cycle of past or future driving cycles of the vehicle.

7. A recommendation method used in a recommendation device that recommends a driver assistance function available for a user who is driving a vehicle, the recommendation method comprising:
acquiring a moving route of the vehicle driven by a target user that is the user as a recommendation target;
specifying one or a plurality of the driver assistance functions recommended to be used on the moving route and use recommended areas where the driver assistance functions are recommended to be used;
evaluating a use record of the target user regarding the driver assistance functions specified by the use recommended function/area specification unit; and
outputting recommendation information that recommends: the driver assistance functions remaining after excluding the driver assistance functions for which an evaluation result of the use record of the target user corresponds to a prescribed condition from the driver assistance functions specified by the use recommended function/area specification unit; and the respective use recommended areas of the driver assistance functions.
